(19) United States
(12) Patent Application Publication
(10) Pub. No.: US 2026/0342155 A1
(43) Pub. Date: Oct. 29, 2026

(54) CORELESS MOTOR

(71) Applicant: AAC Microtech (Changzhou) Co., Ltd., Changzhou City (CN)

(72) Inventors: Lubin Mao, Changzhou (CN); Yun Tang, Changzhou (CN); Wei Song, Changzhou (CN)

(21) Appl. No.: 19/292,971

(22) Filed: Aug. 7, 2025

Related U.S. Application Data
(63) Continuation of application No. PCT/CN2025/092008, filed on Apr. 29, 2025.

(51) Int. Cl. H02K 1/2783; H02K 1/28; H02K 5/15; H02K 7/08; H02K 26/00

(52) U.S. Cl. CPC H02K 1/2783; H02K 1/28; H02K 5/15; H02K 7/083; H02K 26/00

(57) ABSTRACT

The present disclosure discloses a coreless motor including a housing, a rotor, and a stator. The rotor includes a rotating shaft rotatably connected to the front cover and the rear cover; and a magnet unit sleeved on the rotating shaft; A cross section of the rotating shaft along its axis direction is round. The magnet unit includes a plurality of first magnets and a plurality of second magnets alternately arranged in sequence along a circumferential direction of the rotating shaft. Each of the plurality of first magnets is magnetized along a radial direction of the rotating shaft. Adjacent two first magnets are magnetized along opposite directions. Each of the plurality of second magnets is magnetized along a direction orthogonal to the radial direction and the axis direction. Adjacent two second magnets are magnetized along opposite directions. The coreless motor in the present disclosure has higher torque.

### FIELD OF THE PRESENT DISCLOSURE

The present disclosure relates to motor technologies, especially relates to a coreless motor.

### DESCRIPTION OF RELATED ART

Coreless motor has lightweight and excellent heat dissipation performance. Owing to its speedy response and high control precision, the coreless motor is widely applied in electric motor and generator.

In related art, the coreless rotor generally includes a rotating shaft, and a magnet sleeved on the rotating shaft and driven by coil. However, the magnet is integrally molded cylinder with two magnetic poles, which has low driven force resulting in low torque output by the motor.

Therefore, it is necessary to provide an improved coreless motor to overcome the problems mentioned above.

### SUMMARY OF THE INVENTION

One object of the present disclosure is to provide a coreless motor with higher torque.

The coreless motor includes a housing having a receiving space, including a hollow shell with two opposite openings; a front cover covering one of the two openings; and a rear cover covering the other one of the two openings; a rotor, including a rotating shaft rotatably connected to the front cover and the rear cover; and a magnet unit sleeved on the rotating shaft; a stator including a coil affixed to inner surface of the shell and surrounding the magnet unit at an interval; wherein a cross section of the rotating shaft along its axis direction is round; the magnet unit includes a plurality of first magnets and a plurality of second magnets alternately arranged in sequence along a circumferential direction of the rotating shaft; each of the plurality of first magnets is magnetized along a radial direction of the rotating shaft; adjacent two first magnets are magnetized along opposite directions; each of the plurality of second magnets is magnetized along a direction orthogonal to the radial direction and the axis direction; adjacent two second magnets are magnetized along opposite directions.

As an improvement, each of the plurality of first magnets and each of the plurality of second magnets are glued to the rotating shaft.

As an improvement, a projection of the magnet unit along the axis direction is round.

As an improvement, each of the plurality of first magnets includes a first arc surface opposite to the coil, and a first fixation surface fixed to the rotating shaft; each of the plurality of second magnets includes a second arc surface opposite to the coil, and a second fixation surface fixed to the rotating shaft; an arc length of the first arc surface is larger than an arc length of the second arc surface.

As an improvement, the first fixation surface and the second fixation surface are flat surface; along a direction orthogonal to the axis direction and the radial direction, a width of the first fixation surface is larger than a width of the second fixation surface.

As an improvement, further including a first bearing mounted on the front cover, an end of the rotating shaft is ratatably connected to the front cover through the first bearing.

As an improvement, further including a second bearing mounted on the rear cover, the other end of the rotating shaft is ratatably connected to the rear cover through the second bearing.

As an improvement, along the axis direction, a height of the coil is larger than a height of the magnet unit; the end of the coil facing the front cover is closer to the front cover than the end of the magnet unit facing the front cover.

### BRIEF DESCRIPTION OF THE DRAWINGS

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

FIG. 1 is an isometric view of a coreless motor in accordance with an exemplary embodiment of the present disclosure.

FIG. 2 is an exploded view of the coreless motor in FIG. 1.

FIG. 3 is a cross-sectional view of the coreless motor taken along line A-A in FIG. 1.

FIG. 4 is a cross-sectional view of the coreless motor taken along line B-B in FIG. 1.

FIG. 5 is a schematic diagram of magnetization direction of a magnet unit of the coreless motor in FIG. 1.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

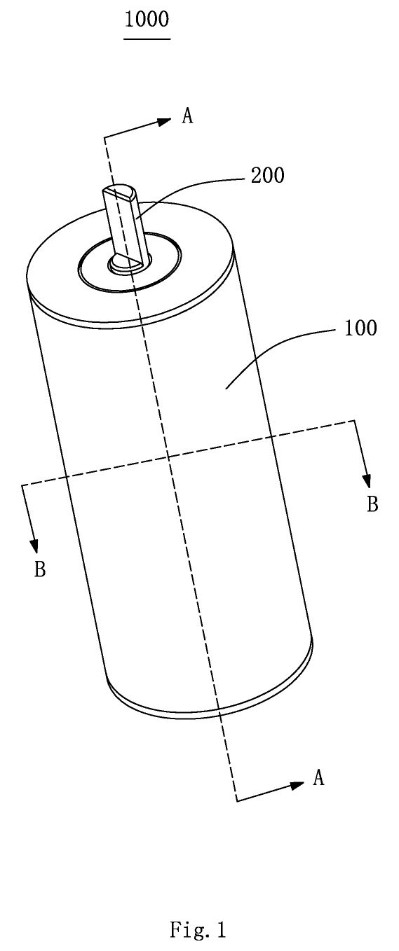

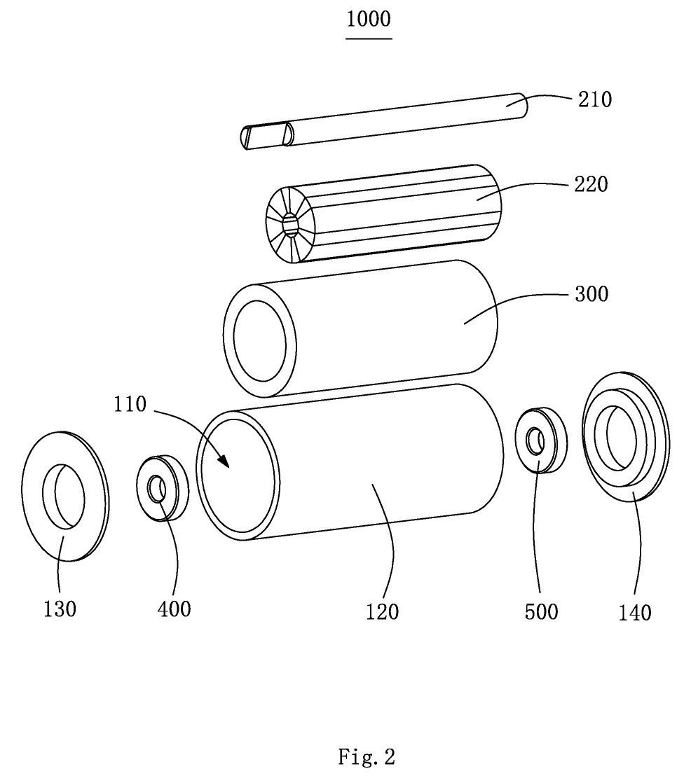

Please refer to FIGS. 1-2 together, a coreless motor 1000 provided by an exemplary embodiment of the present disclosure includes a housing 100 having a receiving space 110, and a rotor 200 and a stator 300 both received in the receiving space 110.

To be specific, as shown in FIG. 2, the housing 100 includes hollow shell 120 with two opposite openings, a front cover 130 covering one of the two openings; and a rear cover 140 covering the other one of the two openings. The receiving space 110 is jointly enclosed by the shell 120, the front cover 130, and the rear cover 140.

Moreover, the rotor 200 includes a rotating shaft 210 rotatably connected to the front cover 130 and the rear cover 140, and a magnet unit 220 sleeved on the rotating shaft 210. It should be noted that the magnet unit 220 is annular. Two opposite ends of the rotating shaft 210 along its axis direction are respectively mounted on the front cover 130 and the rear cover 140. Furthermore, the coreless motor 100 includes a first bearing 400 and a second bearing 500.An end of the rotating shaft 210 is ratatably connected to the front cover 130 through the first bearing 400, the other end of the rotating shaft 210 is ratatably connected to the rear cover 140 through the second bearing 500.

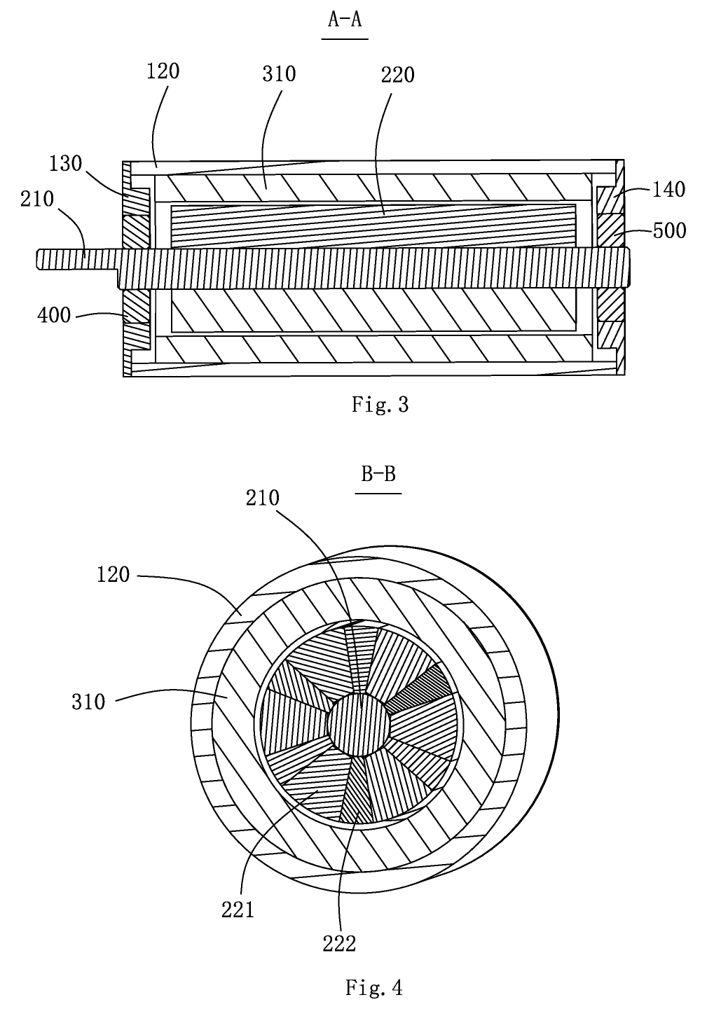

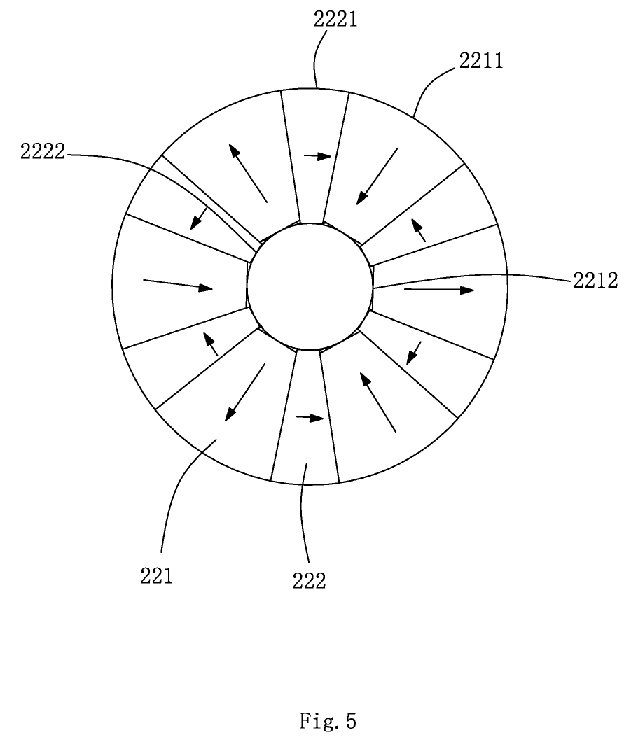

As shown in FIGS. 3-5, a cross section of the rotating shaft 210 along the axis direction is round. The magnet unit 220 includes a plurality of first magnets 221 and a plurality of second magnets 222 alternately arranged in sequence along a circumferential direction of the rotating shaft 210.

Moreover, each of the plurality of first magnets 221 is magnetized along a radial direction of the rotating shaft 210. And adjacent two first magnets 221 are magnetized along opposite directions. Besides, each of the plurality of second magnets 222 is magnetized along a direction orthogonal to the radial direction and the axis direction. Similarly, adjacent two second magnets 222 are magnetized along opposite directions. As shown in FIG. 5, the plurality of first magnets 221 and the plurality of second magnets 222 forma Halbach magnet array, which is adopted to improve magnetic performance of the magnet unit 220 and the torque of the coreless motor 100.

In one embodiment, each of the plurality of first magnets 221 and each of the plurality of second magnets 222 are glued to the rotating shaft 210.

Moreover, the stator 300 includes a coil 310 affixed to inner surface of the shell 120 and surrounding the magnet unit 220 at an interval. Along the axis direction, a height of the coil 310 is larger than a height of the magnet unit 220. It can be seen that the end of the coil 310 facing the front cover 130 is closer to the front cover 130 than the end of the magnet unit 220 facing the front cover 130. Similarly, the end of the coil 310 facing the rear cover 140 is closer to the rear cover 140 than the end of the magnet unit 220 facing the rear cover 140. Thus, outer surface of the magnet unit 220 is wholly opposite to the coil 310, ensuring enough drive force generated by interaction between the coil 310 and the magnet unit 220 for rotor 200.

Furthermore, a projection of the magnet unit 220 along the axis direction is round. Each of the plurality of first magnets 221 includes a first arc surface 2211 opposite to the coil 310, and a first fixation surface 2212 fixed to the rotating shaft 210. Each of the plurality of second magnets 222 includes a second arc surface 2221 opposite to the coil 310, and a second fixation surface 2222 fixed to the rotating shaft 210. In one embodiment, an arc length of the first arc surface 2211 is larger than an arc length of the second arc surface 2221. Besides, the first fixation surface 2212 and the second fixation surface 2222 are flat surface. Along a direction orthogonal to the axis direction and the radial direction, a width of the first fixation surface 2212 is larger than a width of the second fixation surface 2222.

Compared with the related art, the coreless motor in the present disclosure includes a plurality of first magnets and a plurality of second magnets alternately arranged in sequence along a circumferential direction of the rotating shaft. Each of the plurality of first magnets is magnetized along a radial direction of the rotating shaft. Adjacent two first magnets are magnetized along opposite directions. Each of the plurality of second magnets is magnetized along a direction orthogonal to the radial direction and the axis direction. Adjacent two second magnets are magnetized along opposite directions. The first magnet and the second magnets form a Halbach magnet array, effectively improving the magnetic performance of the magnet unit and therefore improving the torque of the coreless motor.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A coreless motor comprising:
a housing having a receiving space, comprising:
a hollow shell with two opposite openings;
a front cover covering one of the two openings; and
a rear cover covering the other one of the two openings;
a rotor, comprising:
a rotating shaft rotatably connected to the front cover and the rear cover; and
a magnet unit sleeved on the rotating shaft;
a stator comprising a coil affixed to inner surface of the shell and surrounding the magnet unit at an interval; wherein
a cross section of the rotating shaft along its axis direction is round; the magnet unit comprises a plurality of first magnets and a plurality of second magnets alternately arranged in sequence along a circumferential direction of the rotating shaft;
each of the plurality of first magnets is magnetized along a radial direction of the rotating shaft; adjacent two first magnets are magnetized along opposite directions;
each of the plurality of second magnets is magnetized along a direction orthogonal to the radial direction and the axis direction; adjacent two second magnets are magnetized along opposite directions.

2. The coreless motor as described in claim 1, wherein each of the plurality of first magnets and each of the plurality of second magnets are glued to the rotating shaft.

3. The coreless motor as described in claim 1, wherein a projection of the magnet unit along the axis direction is round.

4. The coreless motor as described in claim 3, wherein each of the plurality of first magnets comprises a first arc surface opposite to the coil, and a first fixation surface fixed to the rotating shaft; each of the plurality of second magnets comprises a second arc surface opposite to the coil, and a second fixation surface fixed to the rotating shaft; an arc length of the first arc surface is larger than an arc length of the second arc surface.

5. The coreless motor as described in claim 4, wherein the first fixation surface and the second fixation surface are flat surface; along a direction orthogonal to the axis direction and the radial direction, a width of the first fixation surface is larger than a width of the second fixation surface.

6. The coreless motor as described in claim 1, further comprising a first bearing mounted on the front cover, an end of the rotating shaft is ratatably connected to the front cover through the first bearing.

7. The coreless motor as described in claim 6, further comprising a second bearing mounted on the rear cover, the other end of the rotating shaft is ratatably connected to the rear cover through the second bearing.

8. The coreless motor as described in claim 1, wherein along the axis direction, a height of the coil is larger than a height of the magnet unit; the end of the coil facing the front cover is closer to the front cover than the end of the magnet unit facing the front cover.
